(19) United States
(12) Patent Application Publication
(10) Pub. No.: US 2006/0015292 A1
(43) Pub. Date: Jan. 19, 2006

(54) Method for detecting and/or monitoring a physical or chemical process variable

(76) Inventor: Wolfgang Lubcke, Steinen (DE)

Correspondence Address: BACON & THOMAS, PLLC, 625 SLATERS LANE, FOURTH FLOOR, ALEXANDRIA, VA, 22314, US

(21) Appl. No.: 10/498,510

(22) PCT Filed: Dec. 18, 2002
(86) PCT No.: PCT/EP02/14434

§ 371 Date: Jul. 12, 2005

(30) Foreign Application Priority Data
Dec. 21, 2001 (DE) 101 63 569.9

(51) Int. Cl. G06F 11/30

(52) U.S. Cl. 702/183

(57) ABSTRACT

The method of the invention determines and/or monitors a physical or chemical process parameter of a liquid or solid medium. The invention provides measurements which represent a physical or chemical parameter, are taken. A measurement approximately constant over a predetermined time interval is used for recognizing a malfunction of a measuring device, especially for recognizing accretions on the sensor side thereof or cumulatively, a measurement approximately constant over a predetermined time interval is used for recognizing a malfunction of the electronics of the measuring device. Also alternatively or cumulatively, a measurement approximately constant over a predetermined time interval is used for recognizing a process-side change and/or a malfunction caused by the process.

The invention relates to a method for determining and/or monitoring a physical or chemical process parameter. Examples of relevant process parameters are the fill level of a fill substance in a container, the temperature, pressure, density, viscosity, flow rate, turbidity, conductivity, pH-value and/or chemical composition of a medium being measured.

Problems can occur in the determining and/or monitoring of a process parameter, when deposits accumulate on the parts of the measuring apparatus that come in direct or indirect contact with the medium being measured. The term “accretion build-up” may be used in this connection. The danger of accretion build-up on the measuring apparatus is greater in the case of sticky, viscous, splashing and stirred fill substances. It can, however, also occur, for example, in the case of microwave measuring devices, by condensation on the antenna. Such measuring devices are used for determining the fill level of a fill substance. While it is true that microwave antennas tolerate a certain amount of fouling, nevertheless measurement becomes errored or fails completely, as soon as the fouling, or the accretion build-up, as the case may be, exceeds a tolerable amount. Thus, in the case of significant accretion build-up on the antenna, the measurement signal becomes finally completely absorbed; the useful echo signal, which represents the current fill level of the fill substance, then can no longer be detected. Pressure sensors, especially hydrostatic pressure sensors, or vibration detectors, and even flow sensors and sensors, with which analyses are performed, behave analogously.

When known measuring devices no longer deliver a measurement, there are various solutions known from the state of the art for getting around this state of zero information: In the case of vibration detectors, which are, for the most part, employed as overflow, or empty, safeguards, an alarm signal is promptly issued; and the last measurement accepted as valid is ‘frozen’. In some cases, the frozen measurement remains on the display of the measuring device. The consequence of an alarm is usually that the affected parts of a process plant are promptly shut down. In order to avoid time- and cost-intensive analyses, usually the defective measuring device is replaced by a functioning one. If the cause of the malfunction is due e.g. to an accretion build-up, replacement of the measuring device is, naturally, an unreasonably expensive solution for the problem.

An object of the invention is to provide a method which assures reliable measurement registration and error recognition, or prediction, for a measurement device.

According to a first version of the method of the invention, the object is achieved by the following method steps: Measurements representing the physical or chemical process parameters are taken; a measurement that remains approximately constant over a predetermined time interval is automatically used for recognition of a malfunction, especially for recognition of accretion, at the sensor end of a measuring device; alternatively, or cumulatively, a measurement that remains approximately constant over a predetermined time interval is automatically used for recognition of a malfunction of the electronics of the measuring device; alternatively, or cumulatively, a measurement that remains approximately constant over a predetermined time interval is automatically used for recognition of a change on the process side and/or a malfunction brought about by the process.

A change on the process side can occur, for example, when a microwave measuring device is determining the fill level through a dielectric window in the top of the container. If the dielectric window becomes fouled, also in this case, a more or less marked peak in the echo curve will indicate the degree of the fouling. If one follows the history of the measurements, a clear statement can also be made as to when, at the latest, the fouling must be cleaned away, in order to assure the continued functioning of the measuring device.

The object is additionally achieved by a method having the following method steps: during a plurality of measurement cycles, measurements representing the physical or chemical process parameters are taken; on the basis of the measurements, the average rate of change of the measurements and/or the average length of a time interval, in which the measurements are constant, is determined; a malfunction is indicated, when the average rate of change of the measurements is subceeded, i.e. fallen below, and/or when the average length of the time interval, in which a measurement remains constant, is exceeded.

According to an advantageous further development of the method of the invention, a trend analysis is used to recognize whether the measurement device for determining a physical or chemical process parameter is working correctly or malfunctioning. Along with this yes/no information, it is also possible according to the invention, to make a statement concerning in which area of the measuring device the cause of the malfunctioning is to be sought. Especially used here is the knowledge that malfunctions only very seldom occur abruptly in a measuring device. Instead, malfunctions usually establish themselves unobtrusively. Only after a certain tolerance value is exceeded does the measuring device fail completely and deliver subsequently a measurement which no longer changes with time.

Consider a fill level measuring device radiating high-frequency measuring signals from an antenna freely in the direction of the surface of a fill substance. By way of example, the MICROPILOT instrument is a radar-based measuring device marketed by the assignee. The high-frequency measuring signals are reflected at the surface of the fill substance and return through the antenna into the fill level measuring device. Using the so-called echo curves, which provide the amplitudes of the measuring signals as a function of travel time, or travel distance, as the case may be, the distance is determined between the antenna and the surface of the fill substance. The measuring signal reflected on the surface of the fill substance, the so-called useful signal, is characterized in the echo curve by a more or less pronounced peak. Using the functional dependence between the peak and the travel time, the total travel distance of a measuring signal from the antenna to the surface of the fill is determined. With known container height, the measurements can then be used for a simple calculation of the fill level of the fill substance in the container.

Depending on process conditions, particles of the fill substance build up more or less quickly in the antenna area of the measuring device. With time, this so-called accretion build-up becomes so large that eventually only a small fraction of the energy of the measuring signal can leave the antenna, i.e. the sensor side of the measuring device, in the direction of the surface of the fill substance. This leads to a situation where the amplitude of the useful signal reflected at the surface can, after a certain degree of fouling, no longer be detected. As a result, the measurement becomes a constant. As already stated, the known solutions of the state of the art then have the last detected measurement frozen, an alarm is issued, and, if need be, the affected part of the process plant is shut down. Questionable in these solutions is, however, whether the constant measurement is to be attributed to a malfunction or simply to the fact that, in the considered time period, no change actually occurred in the measurement.

According to the invention, a reliable size is determined, as a function of the process to be monitored, for the time interval in which a constant measurement is tolerable. Preferably, this time interval is determined as the average of a plurality of individual measurements. The tolerances are subsequently determined on the basis of deviations, or else they can be set manually. Only in the case where no change occurs in the measurement during the usually maximum occurring time interval for a particular application is this interpreted as a malfunction of the measuring device.

Additionally, the historical data can be queried, thus, data, which makes it possible to follow the time variance of a measurement, or, more concretely, the echo curve over an arbitrarily long period of time. On the basis of these historical data, a clear statement can be made in the case of a malfunction of the measuring device that the malfunction comes from e.g. an accretion build-up on the sensor side of the measuring device. Or, a clear statement can be made that a defect has occurred in the electronics of the measuring device. In the first case, it is sufficient, if the accretion build-up is removed from the sensor side of the measuring device. A replacement of the measuring device is not required.

Of course, the method of the invention can be used for any type of measuring device. Examples are pressure sensors, vibration limit switches, or pH-electrodes. Pressure sensors and vibration limit switches are marketed by the assignee e.g. under the designations CERABAR and LIQUIPHANT, respectively.

An advantageous further development of the method of the invention provides that a malfunction is indicated, when the rate of change of the measurements is smaller than the minimum determined rate of change and/or when the time interval, in which the measurements are approximately constant, is greater than the maximum determined time interval. Here, dynamic quantities are used for the precise determination of a malfunction in a measuring device.

Additionally, in a preferred embodiment of the method of the invention, it is provided that a malfunction is first indicated, when a predetermined tolerance range for the rate of change of the measurements, or, respectively, the time interval, in which a measurement is approximately constant, is subceeded, or, respectively, exceeded. In this way, the risk of an unnecessary, false alarm is further minimized. The tolerances are naturally chosen such that any risks of accidents in the monitored process can be excluded. Of course, the temporal changes of the measurements, respectively the measured data, from which the process parameters are, in the end, derived, permit recognition of whether the functional efficiency of a measuring device is declining. Additionally, a statement can also be made as to when the measuring device is expected to fail finally (i.e. predictive maintenance). Corresponding information is made available to the operating personnel. Along with the information that a malfunction is present, a statement can also be made as to the type of malfunction.

The object is additionally achieved in a third variant of the method of the invention by the following method steps: Measurements with reference to the physical or chemical process parameters are taken over a predetermined time interval; for the case that the measurement remains approximately constant during the time interval, at least one further process and/or system parameter is determined; taking this process and/or system parameter into consideration, a plausibility check is performed, wherein the plausibility check is used to determine whether the constant measurement is to be interpreted as a malfunction; in the case of a recognized malfunction, an error report occurs. This embodiment reduces the danger of a false alarm almost to zero.

The invention additionally relates to a method for monitoring a measuring device working on the travel time principle and determining, or monitoring, as the case may be, the fill level of a fill substance in a container. The measuring device has an electronics section, a coupling section and an antenna. High-frequency measuring signals are emitted in the direction of the fill substance and reflected on the surface of the fill substance; subsequently, the echo curve is determined, which shows amplitude of the measuring signals as a function of the travel time or the travel distance of the measuring signals; at least one echo signal, which occurs in front of the useful echo signal representing the fill level of the medium in the container is used for recognizing a malfunction in the electronics section or in the coupling section.

According to an advantageous further development of the method of the invention, the current echo curve is compared with a stored echo curve; a malfunction and the type of malfunction are recognized and interpreted on the basis of a variance between the current echo curve and the stored echo curve. Since most malfunctions establish themselves unobtrusively, the historical data permits determination of when the measuring device will fail (i.e. predictive maintenance).

The invention will now be explained in greater detail on the basis of the drawings, whose figures show as follows:

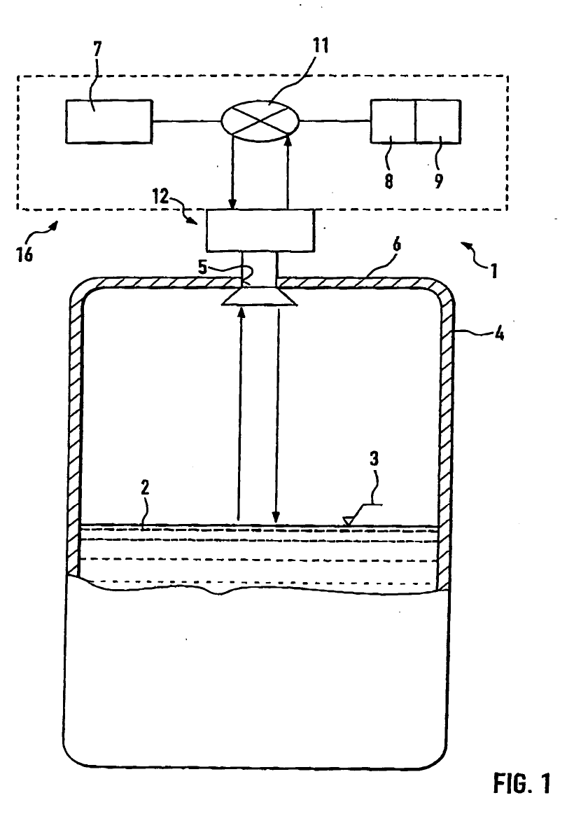

FIG. 1: a schematic drawing of a fill level measuring device suitable for performing the method of the invention,

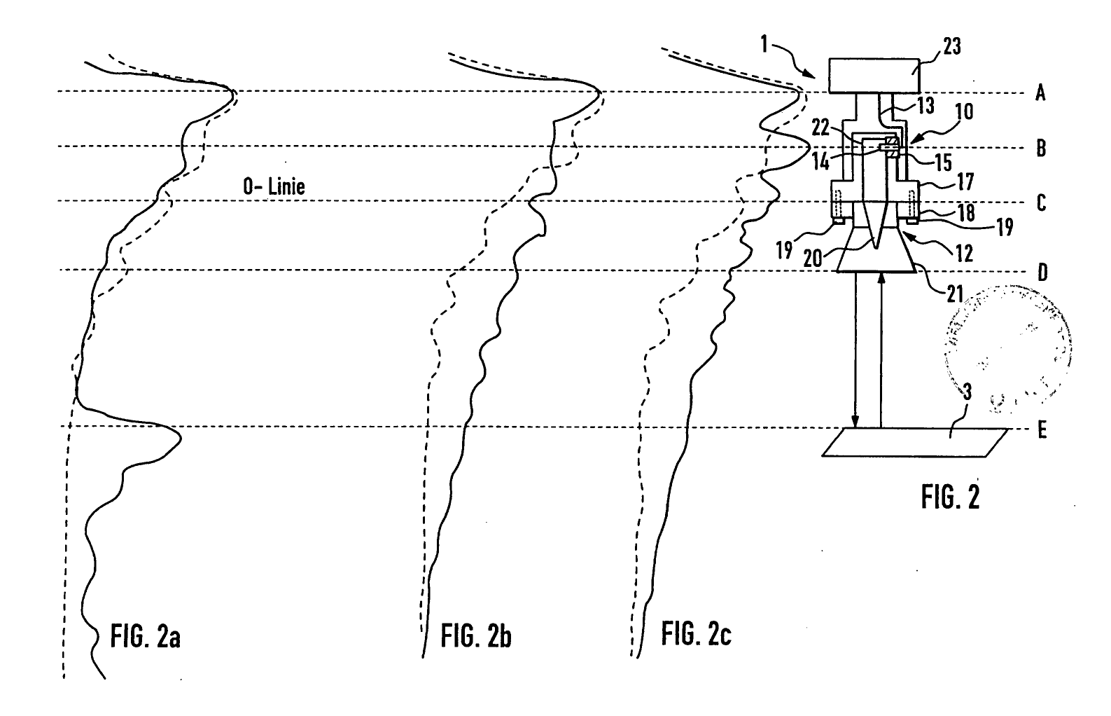

FIG. 2: a schematic drawing of a fill level measuring device,

FIG. 2a: a schematic drawing of an echo curve under normal conditions,

FIG. 2b: a schematic drawing of an echo curve of a fill level measuring device, in which an accretion build-up has exceeded a critical amount, and

FIG. 2c: a schematic drawing of an echo curve of a fill level measuring device, in which e.g. a short circuit has occurred in the area of the coupling section.

FIG. 1 shows a schematic drawing of a measuring device suitable for performing the method of the invention. A fill substance 2 is stored in a container 4. For determining the fill level of the fill substance 2 in the container 4, a fill level measuring device 1 is mounted in an opening 5 in the top 6 of the container 4. In the illustrated case, the measuring signals are microwaves; however, they could also be ultrasonic waves or laser signals. Send signals, especially microwaves, produced in the signal-producing/transmitting-unit 7 are radiated from antenna 12 in the direction of the surface 3 of the fill substance 2. The measuring signals are partially reflected at the surface 3 as echo signals. The echo signals are received and evaluated in the receiving/evaluation unit 8, 9. The correct timing of the emission of the send signals and receipt of the echo signals takes place in the transmit-receive duplexer 11.

Of course, the method of the invention is not only usable in connection with measuring devices using freely radiating antennas 12. In a multitude of areas of application, for example in the petrochemicals, chemicals and foods industries, highly accurate measurements of the fill level of liquids or bulk solids in containers (tanks, silos, etc.) are required. Consequently, measuring devices are being used to an increasing degree, in which short electromagnetic, high-frequency pulses or continuous microwaves are coupled into a conductive element and guided by means of the conductive element into the container storing the fill substance. Examples of these conductive elements are cable and rod probes.

From a physical point of view, these measuring methods make use of the effect by which a portion of the guided high-frequency pulses, or guided microwaves, as the case may be, is reflected at the boundary between two different media, e.g. air and oil, or air and water, due to the abrupt change (discontinuity) in the dielectric constants of the two media. The reflection is then guided back, over the conductive element, into the receiving unit. The reflected fraction is greater, the greater the difference between the dielectric constants of the two media. On the basis of the travel time of the reflected fraction of the high frequency pulses, or the microwaves, as the case may be, the distance to the boundary can be determined. With knowledge of the empty distance of the container, also here the fill level of the fill substance in the container can be calculated. A corresponding device is described, for example, in U.S. Pat. No. 5,361,070. This method is known by the name TDR (Time Domain Reflectometry). Corresponding measuring devices are marketed by the assignee under the designation LEVELFLEX.

FIG. 2 shows schematically a fill level measuring device, which radiates high-frequency measuring signals in the direction of the surface 3 of fill substance 2 (not separately shown). In contrast with the situation with the fill level measuring device 1 shown in FIG. 1, here the essential parts of the sensor side 12 are shown in detail. The measuring signals are produced in the electronics 16, and, in particular, in the high-frequency module 23, and fed over a coax-cable 13 into the hollow conductor, or wave guide, 22. The injection of the measuring signal into the antenna 12 occurs over a transmitting wire 14, which, in the illustrated case, is inserted through the side wall into the hollow conductor 22. The hollow conductor 22 is at least partially filled with a dielectric material 20, which is conically shaped in the direction of transmission of the measuring signals. As in the case of the horn-shaped element 21, the special form of the dielectric material 20 also serves for targeting the transmission and reception of the measuring signals.

FIG. 2 contains five dashed lines A, B, C, D and E. These lines designate marked regions of the fill level measuring device 1. A designates the output of the high-frequency module 23; B marks the area of the coupling 10. C stands for the region where the lower edge of the flange 17 comes to rest. By way of definition, this line is designated the 0-line for the illustrated case, i.e. this is the threshold where measurement of the travel time which the measuring signals require for their path to the surface 3 and back is started. D characterizes the area of the lower edge of the horn-shaped element 21, and E the surface 3 of the fill substance. The regions designated by the letters A, B, C, D, E have in common that they define transitions where the measuring signals experience reflections.

FIGS. 2a to 2c show different echo curves. The dashed curve is always the so-called reference echo curve, which was recorded, for example, at the time of the first operation of the measuring device as its characteristic echo curve.

The solid echo curve in FIG. 2a is a typical echo curve for a fill level measuring device 1 functioning properly. Here, the peak of the so-called useful echo signal is easily detectable. This useful echo signal serves, as already mentioned, for determining the distance from the 0-line to the surface 3 of the fill substance. Clearly visible in FIG. 2a are reflections of the measuring signal occurring at the output of the high-frequency module 23 (indicated in FIG. 1 as the electronics 16), at the area of the coupling 10, at the lower edge of the flange 17 and at the lower edge of the horn-shaped element 21.

A quite different appearance is shown by the two solid-line curves of FIGS. 2b and 2c, with the behavior of these two echo curves being almost identical between the 0-line and the surface 3 of the fill substance. The differences in these two echo curves lie essentially between the 0-line and the line labeled B.

FIG. 2b shows the behavior of the echo curve, when the antenna 12 has a critical accretion build-up, while FIG. 2c is for the case of a short circuit in the area of the coupling 10.

The consequence of both defects is that the fill level measuring device 1 no longer functions. For instance, the measurement remains constant for a period of time which is untypically long for the system. Based on the historical data or based on different regions of the echo curve, it is possible, moreover, to determine reliably the cause of the malfunction. As already mentioned, the difference between the echo curves of FIGS. 2b and 2c lies in the area before the 0-line. While the echo curve of FIG. 2b has a plateau in the area of the line B, the corresponding echo curve in FIG. 2c shows a clear peak. This marked peak indicates reliably that a short circuit has occurred in the area of the coupling 10 The measuring device 1 is, therefore, defective and must be promptly replaced. In contrast, the appearance of the corresponding section of the echo curve in FIG. 2b shows that the malfunction of the fill level measuring device 1 is due to an accretion build-up in the area of the antenna. In this case, it is sufficient to clean the antenna, in order to restore the proper functioning of the fill level measuring device.

1-12. (canceled)

13. A method for determining and/or monitoring a physical or chemical process parameter of a liquid or solid medium, wherein measurements are taken representing the physical or chemical process parameter, the method comprises the steps of:
using a measurement which is approximately constant over a predetermined time interval for recognizing a malfunction of a measuring device, especially for recognizing an accretion on the sensor-side of the measuring device; and/or
using a measurement which is approximately constant over a predetermined time interval for recognizing a malfunction of the electronics of the measuring device; and/or
using a measurement which is approximately constant over a predetermined time interval to recognize a change on the process-side and/or a malfunction caused by the physical or chemical process.

14. A method for determining and/or monitoring a physical or chemical process parameter of a liquid or solid medium in a container, comprising the steps of:
taking measurements representing the physical or chemical process parameter over a plurality of measurement cycles; and
making a determination based on the measurements, of the average rate of change of the measurements and/or the average length of a time interval in which the measurements are constant, wherein:
a malfunction is indicated, when the average rate of change of the measurements is subceeded and/or when the average length of the time interval, in which a measurement remains constant, is exceeded.

15. The method as claimed in claim 14, wherein:
a malfunction is indicated, when the rate of change of the measurements is smaller than the minimum determined rate of change and/or when the time interval, in which the measurements are approximately constant, is greater than the maximum determined time interval.

16. The method as claimed in claim 14, wherein:
a malfunction is first indicated, when a predetermined tolerance range of: the rate of change of the measurements, or, respectively, the time interval, in which a measurement is approximately constant, is subceeded, or, respectively, exceeded.

17. A method for determining and/or monitoring a physical or chemical process parameter of a liquid or solid medium in a container, comprising the steps of:
taking measurements respecting the physical or chemical process parameter over a predetermined time interval, wherein, for the case that the measurement remains approximately constant during the time interval, at least one additional process and/or system parameter is determined;
using said additional process and/or system parameter to perform a plausibility check, wherein the plausibility check is used to determine whether the constant measurement is to be interpreted as a malfunction; and
reporting an error in the case of the occurrence of a recognized malfunction.

18. The method as claimed in claim 13, wherein:
the measurements are stored over a predetermined time period as historical data; and
a malfunction, which establishes itself unobtrusively, is recognized based on the historical data.

19. The method as claimed in claim 17, wherein:
the measurements are stored over a predetermined time period as historical data; and
a malfunction, which establishes itself unobtrusively, is recognized based on the historical data.

20. The method as claimed in claim 13, wherein:
the fill level of the medium in a container, the mass, the temperature, the pressure, the density, the viscosity, the flow rate, the turbidity, the conductivity, the pH-value and/or the chemical composition of the medium is determined.

21. The method as claimed in claim 20, wherein:
the fill level of a fill substance in a container is determined via the travel time of freely radiated or guided measuring signals.

22. The method as claimed in claim 21, wherein:
a measurement representing the fill level is determined via the echo curve, which represents the amplitudes of the measuring signals as a function of travel time or travel distance.

23. The method as claimed in claim 17, wherein:
the fill level of the medium in a container, the mass, the temperature, the pressure, the density, the viscosity, the flow rate, the turbidity, the conductivity, the pH-value and/or the chemical composition of the medium is determined.

24. The method as claimed in claim 20, wherein:
the fill level of the medium in a container, the mass, the temperature, the pressure, the density, the viscosity, the flow rate, the turbidity, the conductivity, the pH-value and/or the chemical composition of the medium is determined.

25. The method as claimed in claim 21, wherein:
a measurement representing the fill level is determined via the echo curve, which represents the amplitudes of the measuring signals as a function of travel time or travel distance.

26. A method for monitoring the malfunction of a field device for determining and/or monitoring the fill level of a medium in a container, wherein the field device has an electronics section, a coupling section and an antenna, the method comprising the steps of:
emitting high-frequency measuring signals in the direction of the fill substance and reflected at the surface of the fill substance;
determining an echo curve, which shows the amplitudes of the measuring signals as a function of the travel time or travel distance of the measuring signals; and
using at least one echo signal, which occurs before the actual useful echo signal representing the fill level of the medium in the container, for recognizing a malfunction in the electronics section or the coupling section.

27. The method as claimed in claim 26, further comprising the steps of:
comparing the current echo curve with a stored echo curve; and
recognizing and interpreting a malfunction and the kind of malfunction based on a variance between the current echo curve and the stored echo curve.

28. Method as claimed in claim 26, wherein:
historical data is used for recognizing a malfunction of the fill level measuring device.

29. Method as claimed in claim 27, wherein:
historical data is used for recognizing a malfunction of the fill level measuring device.
